(19) United States
(12) Patent Application Publication
(10) Pub. No.: US 2008/0203077 A1
(43) Pub. Date: Aug. 28, 2008

(54) Heating System Comprising a Ptc Element, Especially For a Motor Vehicle

(75) Inventors: Michel Brun, Rustenhart (FR); Geoffrey Denny, Rixhem (FR); Gerard Eckerlen, Rouffach (FR); Erwan Gogmos, Colmar (FR); Pascal Miss, Selestat (FR); Mathieu Mougey, Rixheim (FR); Nicolas Robin, Mulhouse (FR); Christophe Schmittheisler, Epfig (FR)

Correspondence Address: LEYDIG VOIT & MAYER, LTD, 700 THIRTEENTH ST. NW, SUITE 300, WASHINGTON, DC, 20005-3960, US

(73) Assignee: BEHR FRANCE ROUFFACH SAS, Rouffach (FR)

(21) Appl. No.: 11/996,548

(22) PCT Filed: Jul. 4, 2006
(86) PCT No.: PCT/EP06/06497

§ 371 Date: Mar. 27, 2008

(30) Foreign Application Priority Data
Jul. 26, 2005 (EP) 05291602.0

(51) Int. Cl. B60L 1/02; H05B 3/02

(52) U.S. Cl. 219/202; 219/494

(57) ABSTRACT

The invention relates to a heating system (1), especially for a motor vehicle, comprising at least one PTC element and a housing (7) which contains the PTC element and through which the air to be heated flows. The invention heating system also comprising a heating control device (3) which is at least partially arranged in the housing (7) and comprises at least one cooling body (6) arranged in the air stream of the air to be heated. A blower control device (5) is arranged in the housing (7), next to the heating control deice (3).

### BACKGROUND OF THE INVENTION

The invention pertains to a heating system with a PTC element, particularly for a motor vehicle, according to the preamble of Claim 1.

DE 102 34 470 A1 discloses an electric heater that comprises an electric heating device, particularly a PTC heating device, and an electronic control device arranged thereon in order to control the heating current supplied to the heating device. In order to carry off the dissipated heat generated in the electronic control device, cooling devices provided on the control device are arranged in the flow of the air to be heated. The electronic control for the heating current is accommodated in a housing, wherein cooling devices in the form of cooling fins or cooling ribs originating from a rib base are provided on the housing. The control device and the heating device are arranged transverse to the flow of the air to be heated and spaced apart from one another, wherein the cooling fins are situated in the intermediate space between the control device and the heating device.

DE 101 02 671 C2 discloses an electric heater for a motor vehicle with one or more heating elements and a control circuit for controlling the output of the heating elements, wherein the control circuit comprises one or more power semiconductors that are arranged on a circuit substrate. On the side that faces away from the power semiconductors (underside), the circuit substrate is integrally connected to a metal plate that is provided for being connected to the ground potential. The metal plate is electrically insulated relative to the strip conductors that are situated on the underside of the circuit substrate and provided for carrying a voltage. The control circuit is arranged in a housing, wherein one or more cooling elements are provided outside the housing and a thermally conductive connection connects the metallic plate arranged in the housing to the cooling elements.

Systems in which electric heating devices are provided which also feature an arrangement for cooling the control device for controlling the heating elements are also known from DE 199 57 452 A1, DE 199 25 757 A1 and DE 197 38 318 A1.

### BRIEF SUMMARY OF THE INVENTION

The invention is based on the objective of making available an improved heating system with a PTC element.

This objective is attained with a heating system with the characteristics of Claim 1. Advantageous embodiments form the objects of the dependent claims.

According to the invention, a heating system, particularly for a motor vehicle, comprises at least one PTC element and a housing, in which the PTC element is arranged and through which the air to be heated flows, as well as a heater control device that is at least partially arranged in the housing and features at least one cooling element, wherein the heater control device is combined, particularly realized in the form of a unit, with at least one accessory unit control device. The number of individual control devices can be reduced due to the fact that the heater control device is combined with the accessory unit control device. Although it is preferred that, in addition to the cooling element(s) for the heater control device, at least one cooling element be provided for the accessory unit control device, it would also be possible to provide common cooling elements.

The at least one accessory unit control device preferably consists of a blower control device. However, it may also consist of other accessory units, particularly units that are connected to the air-conditioning system and/or fulfill air distribution functions, for example, distribution flaps, air outlets, etc.

A common data bus system is preferably provided for the control of the heater and the control(s) of the accessory unit(s). This data bus system preferably consists of a CAN (Controller Area Network) or LIN (Local Interconnect Network) bus system. The data bus system preferably is also arranged in the housing such that the signal and data transmission need only to take place over short distances.

The heater control device preferably is directly connected to the PTC element such that additional wiring can be eliminated. This simplifies assembly, and the manufacturing costs can be reduced.

At least one cooling element of the heater control device and/or the accessory unit control device(s) preferably protrudes into the air channel for the air to be heated or is arranged in the flow of the air to be heated, wherein it is particularly preferred that said cooling element is arranged upstream of the PTC element, referred to the airflow direction. The air to be heated is still cool in this region, i.e., the cooling capacity is at its maximum and the electronics can be protected from overheating.

It is preferred to provide at least one interface for at least one sensor device, preferably a temperature sensor. The temperature sensor is preferably arranged in the vicinity of the auxiliary heater, i.e., the PTC elements. However, it would also be conceivable that no sensor interface/temperature sensor interface is provided, wherein sensory monitoring/temperature monitoring does not take place or is realized otherwise in such instances.

It is preferred to provide at least one bus interface, via which the heater and accessory unit control devices receive information from the operating element and the vehicle, for example, the desired temperature, the desired blower speed or the available electric power. This makes it possible to control the auxiliary heater and the accessory unit, e.g., the blower. The bus interface can also be used for transmitting registered sensor data to other locations.

The heating system preferably comprises several PTC elements that can be controlled individually and/or in groups of at least two PTC elements. This makes it possible generally to control the temperature in a demand-actuated fashion. Furthermore, one heating branch can be switched off in case of a defect so that it is not necessary to immediately replace the entire heating system because heating can continue with the aid of the remaining heating branches.

The heater control device and the accessory unit control device are preferably integrated into a housing wall or form part of the housing wall, wherein at least the cooling elements that are connected to the power electronics are arranged on the inner side of the housing, i.e., in the region of the flow of the air to be heated. This design of the heater makes it possible to save structural space. The wiring cost can thereby be further reduced.

In order to improve heat dissipation, corrugated ribs can be advantageously arranged in the immediate vicinity of the PTC elements. If so required, this can also be realized in connection with the cooling elements.

The heating system preferably features at least one PTC element with an operating temperature of 80-120° C. so that the risk of overheating can also be minimized in the region of the power electronics.

The heating system is preferably arranged outside the air-conditioning unit in the form of a decentralized auxiliary heater, for example, in corresponding air channels in the A-column, the B-column, the C-column or in a door, but may also be arranged in the air-conditioning unit.

### BRIEF DESCRIPTION OF THE SEVERAL VIEWS OF THE DRAWINGS

Two embodiments of the invention are described in greater detail below with reference to the drawings. The drawing shows:

FIG. 1, a highly schematic representation of a section of a first embodiment of an inventive heating system in the region of the heater control device, and

FIG. 2, a highly schematic top view of the heating system according to FIG. 1 in the region of the heater control device.

### DETAILED DESCRIPTION OF THE INVENTION

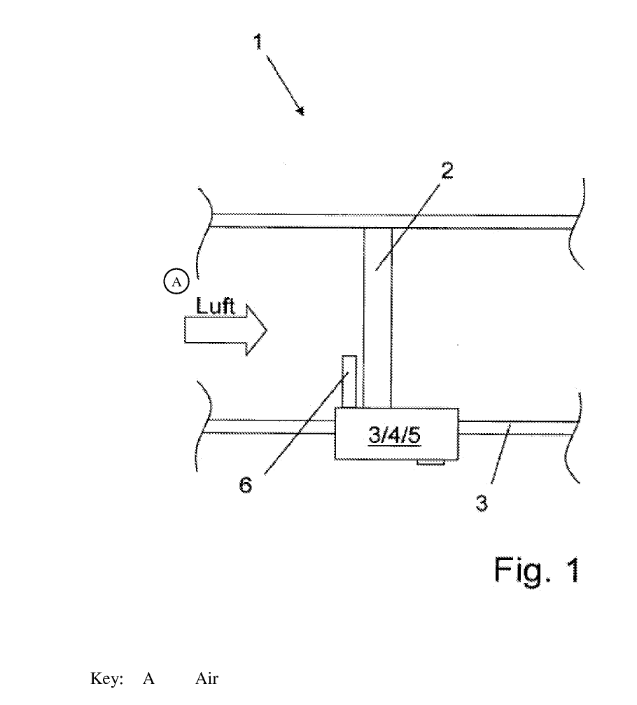

In a PTC heating system 1 with several PTC elements and attached corrugated ribs that are schematically illustrated in FIG. 1 and designated as 2, the PTC elements are respectively bonded between two contact plates, namely by means of a two-component silicone adhesive in the embodiment shown, wherein corrugated ribs are arranged on the outside in order to increase the heat transfer surface, and wherein said corrugated ribs are also attached by means of a two-component silicone adhesive. The multitude of PTC elements with contact plates and corrugated ribs forms an auxiliary heating network that is also referred to as auxiliary heater below.

The control device for the PTC elements is referred to as heater control device 3 below and essentially realized in accordance with DE 197 38 318 A1 in the embodiment shown. In this case, the heater control device 3 features a control logic (a PWM (Pulse Width Modulation) control) and power electronics. The PTC elements or PTC element groups can be controlled separately with the individual electronic switches of the power electronics. It is preferred that an electronic switch, namely one respective transistor, is assigned to each PTC element or each PTC element group. The control logic contains an algorithm for controlling the individual PTC elements or PTC element groups and may be integrated into the heater control device 3 such that the control logic and the power electronics form a single unit as illustrated in the figure.

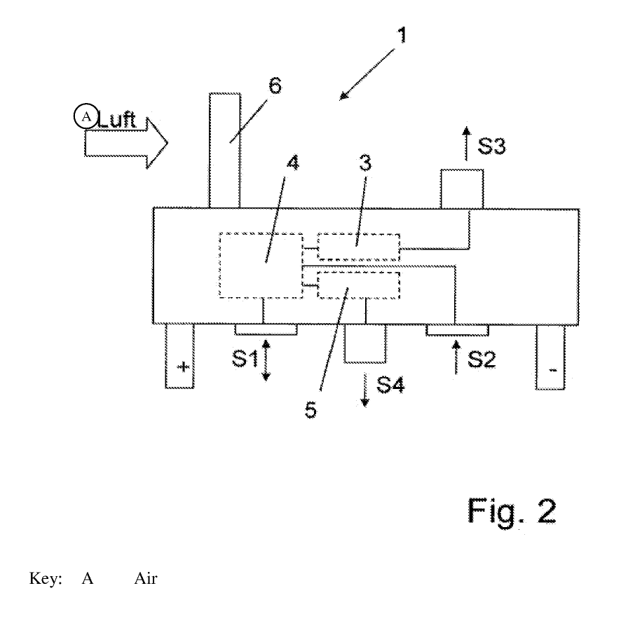

All input signals required for controlling the heater output are supplied via a data bus system 4, for example, a field bus interface such as, in particular, a CAN or LIN in the embodiment shown. If so required, sensor data may also be transmitted via the data bus. Naturally, it is also possible to supply the signals via any analog or digital interface, e.g., a serial interface. In the embodiment shown, the signal inputs for the data bus system 4 consist of a bus interface S1 that also serves as an output, as well as an input S2 of a (not-shown) temperature sensor. The interfaces for the heater control and the blower control are respectively designated as S3 and S4 in FIG. 2.

In contrast to DE 197 38 318 A1, a control device for the blower that is also referred to as blower control device 5 below is provided in addition to the heater control device 3 and arranged adjacent to the heater control device 3, wherein the control is realized via the same data bus system 4.

In order to carry off the accumulated heat of the electronic components, particularly the power electronics, cooling elements 6 are arranged on the heater control device 3 as well as on the blower control device 5 and protrude into the flow of the air to be heated, wherein said control devices are arranged upstream of the PTC elements and the corrugated ribs relative to the normal airflow direction. The cooling elements 6 consist of a material with adequate thermal conductivity, particularly of metal, and should be arranged as close as possible or adjacent to the heat-emitting components.

The entire system, i.e., the data bus system 4, the heater control device 3 and the blower control device 5, as well as the cooling elements 6, the PTC elements and the corrugated ribs are arranged in a plastic housing 7 and collectively form the PTC heating system 1. In this case, the data bus system 4, the heater control device 3 and the blower control device 5 are integrated into the housing wall, wherein an integrated power supply is provided that is identified by the reference symbols + and − in FIG. 2. Although the electrical contacts are realized with the aid of plug-type connectors in the embodiment shown, it would also be possible to solder on the cables or to realize any other type of electrical contact.

In the embodiment shown, the heating system 1 is realized outside the air-conditioning system in the form of a decentralized auxiliary heater that is integrated into an air channel extending in the A-column.

According to a second embodiment that is not illustrated in the figures, PTC elements with an operating temperature between 80° C. and 120° C. are used as a protective measure against overheating rather than the conventional PTC elements with a surface temperature of 130-165° C. used in the first embodiment. In other respects, the design of the heating system corresponds to that of the first embodiment.

A corresponding protection can also be achieved by utilizing a controller that either reduces the power or temporarily switches off the power supply entirely once a certain temperature is reached in the surroundings of the heating system.

1. A heating systems for a motor vehicle, comprising at least one PTC element and a housing in which the PTC element is arranged and through which the air to be heated flows; a heater control device that is at least partially arranged in the housing; at least one cooling element and at least one accessory unit control device, wherein the heater control device is combined with the at least one accessory unit control device.

2. The heating system according to claim 1, wherein at least one accessory unit control device consists of a blower control device.

3. The heating system according to claim 1, further comprising a common data bus system for controlling a heater and for controlling the at least one accessory unit control device.

4. The heating system according to claim 3, wherein the data bus system is arranged in the housing.

5. The heating system according to claim 1, wherein the heater control device is directly connected to the PTC element.

6. The heating system according to claim 1, wherein the at least one cooling element is provided for the accessory unit control device.

7. The heating system according to claim 1, wherein the at least one cooling element is arranged in the flow of the air to be heated.

8. The heating system according to claim 1, wherein the cooling element and/or the accessory unit control device is arranged upstream of the PTC element relative to the airflow direction.

9. The heating system according to claim 1, further comprising at least one sensor device and at least one interface for the at least one sensor device.

10. The heating system according to claim 1, further comprising at least one bus interface.

11. The heating system according to claim 1, comprising several PTC elements that can be controlled individually and/or in groups of at least two PTC elements.

12. The heating system according to claim 1, wherein the heater control device and the accessory control device are integrated into a housing wall or form part of the housing wall, the at least one cooling element is connected to power electronics of the heater control device, and the at least one cooling element and the accessory control device are arranged on an inner side of the housing.

13. The heating system according to claim 1, further comprising corrugated ribs provided adjacent to the at least one PTC element.

14. The heating system according to claim 1, wherein at least one PTC element has an operating temperature of 80-120° C.

15. The heating system according to claim 2, further comprising a common data bus system for controlling a heater and for controlling the at least one accessory unit control device.

16. The heating system according to claim 15, wherein the data bus system is arranged in the housing.

17. The heating system of claim 9, wherein the at least one sensor device comprises a temperature sensor.
